(19) United States
(12) Patent Application Publication
(10) Pub. No.: US 2019/0187405 A1
(43) Pub. Date: Jun. 20, 2019

(54) LENS HOLDER, OBJECT LENS DRIVING DEVICE, OPTICAL PICKUP DEVICE, AND METHOD FOR MANUFACTURING LENS HOLDER

(71) Applicant: Panasonic Intellectual Property Management Co., Ltd., Osaka (JP)

(72) Inventors: Takeshi OHTA, Osaka (JP); Koji IEKI, Osaka (JP)

(21) Appl. No.: 16/267,761

(22) Filed: Feb. 5, 2019

Related U.S. Application Data
(62) Division of application No. 15/816,189, filed on Nov. 17, 2017.

(30) Foreign Application Priority Data
Feb. 8, 2017 (JP) 2017-021689

(51) Int. Cl. G02B 7/10; H02K 3/50; H02K 3/28; G11B 7/09; G11B 7/13; H02K 3/34

(52) U.S. Cl. CPC G02B 7/10; H02K 3/50; H02K 3/345; G11B 7/0933; G11B 7/13; H02K 3/28

(57) ABSTRACT

A lens holder includes a holder body and a winding wire wound around the holder body. The holder body includes a winding body, a first projection and a second projection each projecting from a surface of the holder body, and a winding terminal positioned between the first projection and the second projection, and provided on the surface of the holder body. A part of the winding wire is wound around the winding body to form a coil. An end of the winding wire is wound around the second projection and connected to the winding terminal.

### BACKGROUND

### 1. Technical Field

The present disclosure relates to a lens holder, an object lens driving device, an optical pickup device, and a method for manufacturing a lens holder.

### 2. Description of the Related Art

PTL 1 discloses an object lens driving device including a lens holder. According to the object lens driving device disclosed in PTL 1, a coil part constituted by a winding wire wound beforehand is attached to a lens holder, and then soldered to the lens holder to achieve conductive connection of the winding wire.

### CITATION LIST

### Patent Literature

PTL 1: Unexamined Japanese Patent Publication No. 2000-57601

### SUMMARY

The present disclosure provides a lens holder and others capable of easily achieving conductive connection of a winding wire.

A lens holder according to the present disclosure includes: a holder body; and at least one winding wire wound around the holder body. The holder body includes: at least one winding body; at least one first projection and at least one second projection each projecting from a surface of the holder body; and at least one winding terminal positioned between the at least one first projection and the at least one second projection, and provided on the surface of the holder body. A part of the at least one winding wire is wound around the at least one winding body to form a coil. An end of the at least one winding wire is wound around the at least one second projection and connected to the at least one winding terminal.

The lens holder according to the present disclosure is capable of easily achieving conductive connection of the winding wire.

### BRIEF DESCRIPTION OF THE DRAWINGS

FIG. 1 is a plan view illustrating a part of an optical disc device incorporating an optical pickup device according to an exemplary embodiment;

FIG. 2 is a perspective view of an object lens driving device including a lens holder according the exemplary embodiment;

FIG. 3 is a view illustrating a state that coils for tracking are formed on the lens holder according the exemplary embodiment;

FIG. 4 is a view illustrating a state that coils for focusing are formed on the lens holder according the exemplary embodiment;

FIG. 5 is a view illustrating the lens holder according to the exemplary embodiment in a state before the coils are formed;

FIG. 6 is a flowchart showing a method for manufacturing the lens holder according to the exemplary embodiment;

FIG. 7A is a view illustrating winding of a winding wire around a first projection and a second projection of the lens holder according to the exemplary embodiment; and

FIG. 7B is a view illustrating connection of the winding wire to a winding terminal of the lens holder according to the exemplary embodiment.

### DETAILED DESCRIPTION

An exemplary embodiment is hereinafter described in detail with reference to the drawings as appropriate. However, excessively detailed description may be omitted in some cases. For example, detailed description of well-known matters, and repetitive description of substantially identical configurations may be omitted. This is to avoid that the following description is unnecessarily redundant, and to facilitate the understanding of those skilled in the art.

The accompanying drawings and the following description are only presented to help those skilled in the art fully understand the present disclosure. It is therefore not intended that subject matters described in the scope of the appended claims be limited to the drawings and the description herein.

### Exemplary Embodiment

### [1. Configuration of Optical Pickup Device]

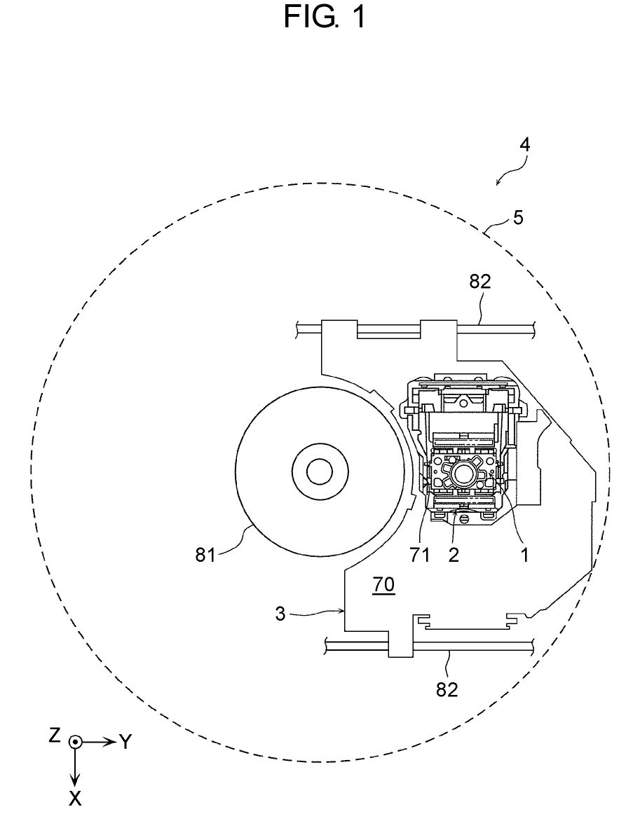

Optical pickup device 3 according to the present exemplary embodiment is initially described. FIG. 1 is a plan view illustrating a part of optical disc device 4 incorporating optical pickup device 3.

Optical disc device 4 is a recording and reproducing device which records and writes information on and into disc (recording medium) 5, such as a compact disc (CD), a digital versatile disc (DVD), and a Blu-ray (registered trademark) disc. Optical disc device 4 includes, inside an outer case, turntable 81 which rotates disc 5, and optical pickup device 3 which irradiates a predetermined position of disc 5 with laser beams. Optical disc device 4 includes a screw shaft (not shown) which extends in parallel with a radial direction of turntable 81, and a pair of guide shafts 82.

Optical pickup device 3 shifts in the radial direction along guide shafts 82 in accordance with driving of the screw shaft. Optical pickup device 3 includes housing 70, and object lens driving device 2 described below, and various types of parts are mounted on housing 70. The various types of parts may include a control integrated circuit (IC), a laser optical system component, and a driver for object lens driving device 2.

### [2. Basic Configurations of Object Lens Driving Device and Lens Holder]

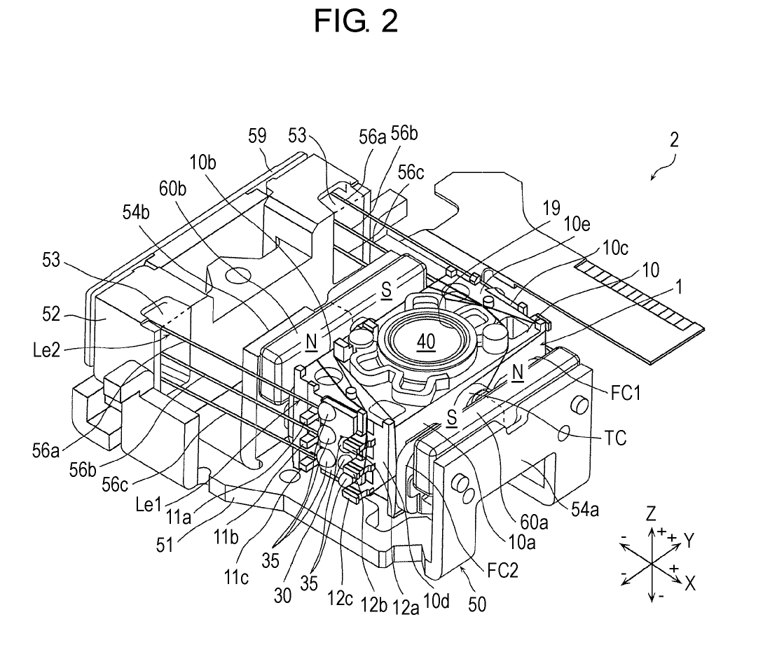

Basic configurations of object lens driving device 2 and lens holder 1 are hereinafter described with reference to FIG. 2.

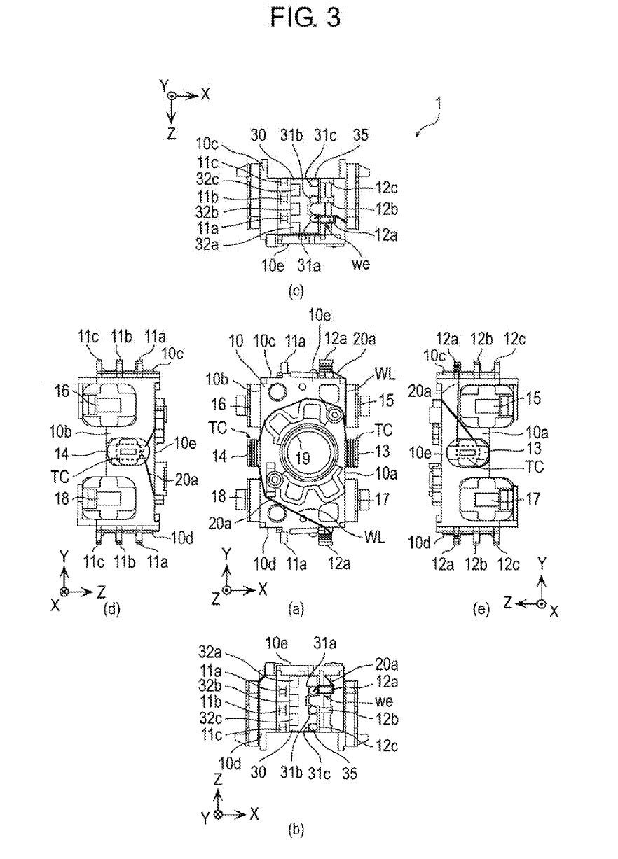

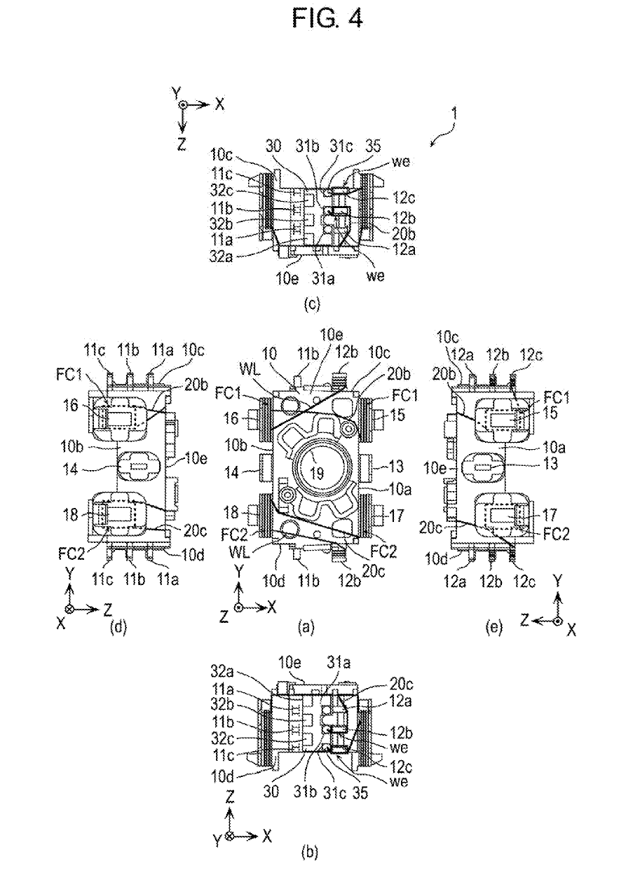

FIG. 2 is a perspective view of object lens driving device 2 according to the exemplary embodiment. FIG. 3 is a view illustrating a state that coils TC for tracking are formed on lens holder 1. FIG. 4 is a view illustrating a state that coils FC1, FC2 for focusing are formed on lens holder 1. In each of FIGS. 3 and 4, (a) is a plan view, (b) is a front view, (c) is a rear view, (d) is a left side view, and (e) is a right side view.

Object lens driving device 2 shifts in a predetermined direction object lens 40 fixed to lens holder 1. In the following description, a focusing direction parallel with an optical axis of object lens 40 is referred to as a Z direction, a tracking direction parallel with the radial direction of turntable 81 is referred to as a Y direction, and a direction perpendicular to both the Z direction and the Y direction at right angles is referred to as an X direction.

As illustrated in FIG. 2, object lens driving device 2 includes lens holder 1, object lens 40, two sets of leads 56a, 56b, 56c, housing 50, a plurality of magnets 60a, 60b, and flexible cable 59. Object lens driving device 2 receives supply of power from optical disc device 4 or optical pickup device 3 via flexible cable 59.

As illustrated in FIGS. 3 through 5, lens holder 1 has a rectangular parallelepiped shape, and includes a pair of side surfaces 10a, 10b facing each other in the X direction, a pair of side surfaces 10c, 10d facing each other in the Y direction, and top surface 10e perpendicular to both side surfaces 10a, 10b, and side surfaces 10c, 10d. Lens holder 1 has a rectangular shape having long sides extending in the Y direction, and short sides extending in the X direction as viewed in the Z direction. For example, lens holder 1 is made of hard synthetic resin. Lens holder 1 includes a cavity extending from a bottom portion to an inner portion to reduce a weight of lens holder 1.

Lens fixing hole 19 is formed in top surface 10e of lens holder 1. Object lens 40 is fitted into lens fixing hole 19 and fixed to lens fixing hole 19.

Winding bodies 13, 15, 17 provided on side surface 10a of lens holder 1 project from side surface 10a. Winding body 13 is disposed at a center in the extension direction of the long sides (Y direction), while winding bodies 15, 17 are disposed on both sides of winding body 13, respectively. Winding bodies 14, 16, 18 provided on side surface 10b of lens holder 1 also project from side surface 10b. Winding body 14 is disposed at the center in the extension direction of the long sides, while winding bodies 16, 18 are disposed on both sides of winding body 14, respectively.

As illustrated in FIG. 3, winding wire 20a of approximately 30 turns is wound around each of winding bodies 13, 14 to form coils TC for tracking. As illustrated in FIG. 4, winding wire 20b of approximately 40 turns is wound around each of winding bodies 15, 16 to form coils FC1 for focusing. Winding wire 20c of approximately 40 turns is wound around each of winding bodies 17, 18 to form coils FC2 for focusing in a rectangular shape. A winding direction of coils FC1 is opposite to a winding direction of coils FC2. Each of coils TC, FC1, FC2 has a rectangular shape, and is disposed such that each coil axis extends in parallel with the X direction. Each of winding wires 20a through 20c is made of a copper material, for example. A coating is formed on each surface of winding wires 20a through 20c.

A plurality of first projections 11a, 11b, 11c and a plurality of second projections 12a, 12b, 12c are provided on each of side surfaces 10c and 10d of lens holder 1. A configuration including first projections 11a through 11c and second projections 12a through 12c will be detailed below.

As illustrated in FIG. 2, two sets of leads 56a, 56b, 56c extend in the X direction. First ends Le1 of two sets of leads 56a, 56b, 56c are respectively connected to side surfaces 10c, 10d of lens holder 1. Each of leads 56a through 56c is constituted by an elastic wire for suspension, and configured to support lens holder 1, and regulate movement of lens holder 1 such that a shift amount of lens holder 1 is limited to a predetermined range. In addition, each of leads 56a through 56c is a wire for power supply, and configured to supply power to a corresponding one of winding wires 20a through 20c (i.e., coils TC, FC1, FC2) after the power is input to flexible cable 59. Each of leads 56a through 56c is made of a beryllium copper material, for example. A metal coating is formed on each surface of leads 56a through 56c.

Housing 50 includes housing body 51 corresponding to a chassis, and support block 52 provided on housing body 51. Housing body 51 is made of metal, such as iron, having magnetic susceptibility. Support block 52 includes a pair of dampers 53 made of a resin material. Second ends Le2 of two set of leads 56a, 56b, 56c are respectively connected to the pair of dampers 53. Housing 50 supports lens holder 1 via leads 56a through 56c. Housing 50 further includes magnet fixing portions 54a, 54b that serve as a yoke, are partially folded, and face each other in the X direction.

Each of magnets 60a, 60b has a quadrangular prism shape. Magnet 60a is fixed to magnet fixing portion 54a via an adhesive or the like, while magnet 60b is fixed to magnet fixing portion 54b via an adhesive or the like. Magnets 60a, 60b respectively include facing surfaces facing each other in the X direction. The facing surface of magnet 60a faces side surface 10a of holder body 10, while the facing surface of magnet 60b faces side surface 10b of holder body 10. For example, the facing surface of magnet 60a on the Y-direction positive side forms a north pole, while the facing surface of magnet 60a on the Y-direction negative side forms a south pole, with a boundary located at a center of magnet 60a in the longitudinal direction (Y direction). On the other hand, the facing surface of magnet 60b on the Y-direction positive side forms a south pole, while the facing surface of magnet 60b on the Y-direction negative side forms a north pole, with a boundary located at a center of magnet 60b in the longitudinal direction. This structure generates a magnetic field in a space sandwiched between magnets 60a, 60b.

An upper side of each of rectangular coils FC1, FC2 (side located on Z-direction positive side) is disposed between magnets 60a, 60b. Accordingly, when current flows in coils FC1, FC2, a force in the Z direction is generated in each of coils FC1, FC2. Accordingly, lens holder 1 shifts in the Z direction (focusing direction).

Each side of rectangular coils TC located on the Y-direction positive side is affected by a magnetic field directed toward the X-direction negative side, while each side of coils TC located on the Y-direction negative side is affected by a magnetic field directed toward the X-direction positive side. Accordingly, when current flows in each coil TC, a force in the Y direction is generated in each coil TC, and shifts lens holder 1 in the Y direction (tracking direction). The forces generated in the upper side and the lower side of coils TC are canceled by each other.

As described above, lens holder 1 of object lens driving device 2 is configured to shift in the focusing direction or the tracking direction in accordance with supply of power to coils FC1, FC2 or coils TC.

### [3. Configuration of Lens Holder]

A detailed configuration of lens holder 1 is now described.

As described above, winding wire 20a constitutes coils TC for tracking, while winding wires 20b, 20c constitute coils FC1, FC2 for focusing, respectively. Coils TC, FC1, FC2 are formed by routing winding wires 20a through 20c, respectively, with ends we of winding wires 20a through 20c fixed to predetermined positions, and winding a part of winding wires 20a through 20c around corresponding winding bodies 13 through 18. Lens holder 1 according to the present exemplary embodiment has a following structure in areas of ends we of winding wires 20a through 20c.

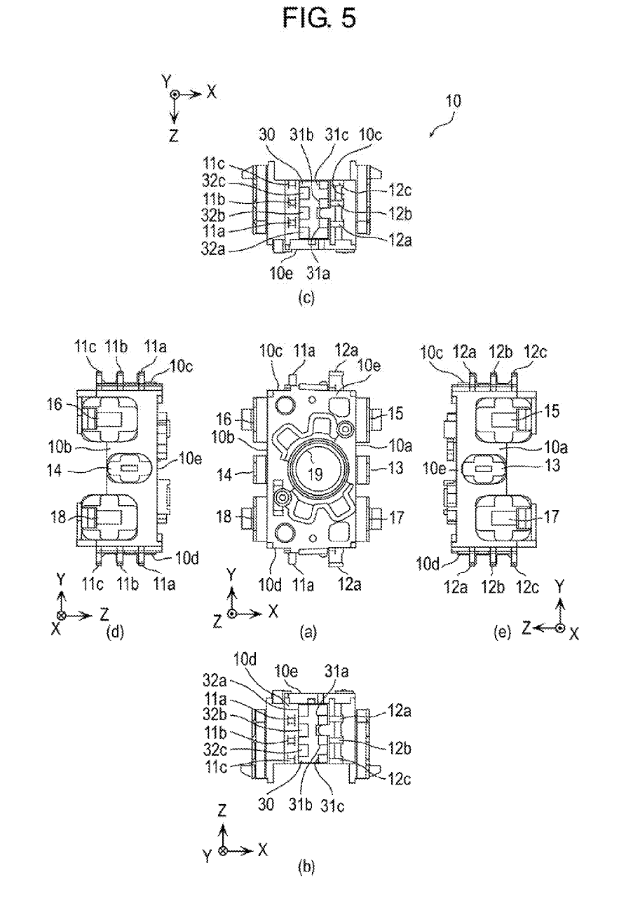

FIG. 5 is a view illustrating lens holder 1 in a state before coils TC, FC1, FC2 are formed. In FIG. 5, (a) is a plan view, (b) is a front view, (c) is a rear view, (d) is a left side view, and (e) is a right side view.

As illustrated in FIG. 5, first projections 11a, 11b, 11c, and second projections 12a, 12b, 12c are provided on side surface 10c of holder body 10. On the other hand, second projections 12a, 12b, 12c, and first projections 11a, 11b, 11c are provided on side surface 10d.

For example, second projection 12a on side surface 10c is a portion around which one end we of winding wire 20a is wound and fixed, while second projection 12a on side surface 10d is a portion around which other end we of winding wire 20a is wound and fixed. First projection 11a on side surface 10c is a portion to which one end we of winding wire 20a is temporarily attached, while first projection 11a on side surface 10d is a portion to which other end we of winding wire 20a is temporarily attached, during wiring on lens holder 1.

First projection 11a is disposed at a predetermined distance from second projection 12a in the X direction. More specifically, first projection 11a is disposed away from second projection 12a by a length ranging from 1 mm to 10 mm (inclusive) in the X direction to secure a sufficient space for insertion of tweezers or a soldering tool between first projection 11a and second projection 12a after a winding process. This configuration also applies to first projections 11b, 11c and second projections 12b, 12c provided on respective side surfaces 10c, 10d.

Each of first projections 11a through 11c and second projections 12a through 12c on side surface 10c has a columnar shape, and projects perpendicularly from side surface 10c. Similarly, each of first projections 11a through 11c and second projections 12a through 12c on side surface 10d has a columnar shape, and projects perpendicularly from side surface 10d. For example, a projection amount of first projection 11a from side surface 10c falls within a range from 5 times to 50 times (inclusive) larger than a diameter of winding wire 20a.

First wiring substrate 30 is provided between first projections 11a through 11c and second projections 12a through 12c on side surface 10c. Similarly, second wiring substrate 30 is provided between first projections 11a through 11c and second projections 12a through 12c on side surface 10d. Each of wiring substrates 30 is bonded and fixed to side surface 10c or 10d of holder body 10 to be combined with holder body 10 into one body. Each of wiring substrates 30 includes a notch for alignment with holder body 10.

A plurality of winding terminals 31a, 31b, 31c, and a plurality of lead terminals 32a, 32b, 32c are formed on each surface of wiring substrates 30. Each of winding terminals 31a through 31c and lead terminals 32a through 32c constitutes a land-shaped electrode.

First ends Le1 of leads 56a, 56b, 56c described above are connected to lead terminals 32a, 32b, 32c, respectively, via solder 35 in one-to-one correspondence. Lead terminals 32a, 32b, 32c are connected to winding terminals 31a, 31b, 31c, respectively, via surface wiring or inner wiring of wiring substrate 30 in one-to-one correspondence. Winding terminals 31a, 31b, 31c are connected to ends we of winding wires 20a, 20b, 20c, respectively, via solder 35 in one-to-one correspondence. This wiring structure achieves power supply to respective coils TC, FC1, FC2.

A positional relationship between first projection 11a, lead terminal 32a, winding terminal 31a, and second projection 12a is described herein. For example, winding terminal 31a is disposed closer to second projection 12a than lead terminal 32a is. More specifically, winding terminal 31a is positioned between first projection 11a and second projection 12a. In further detail, winding terminal 31a is positioned on a line connecting first projection 11a with second projection 12a when viewed in a direction perpendicular to side surface 10c. Winding terminal 31a may be disposed at a position between first projection 11a and second projection 12a and not on the line connecting first projection 11a with second projection 12a. In addition, lead terminal 32a is disposed closer to first projection 11a than winding terminal 31a is. Lead terminal 32a is positioned between first projection 11a and second projection 12a and on an obliquely upper side of first projection 11a. The foregoing positional relationship is also applicable to positional relationships between first projections 11b, 11c, lead terminals 32b, 32c, winding terminals 31b, 31c, and second projections 12b, 12c.

Presence or absence of winding of winding wire 20a is now described. As illustrated in FIG. 3, for example, end we of winding wire 20a is wound around corresponding second projection 12a with 2 through 10 turns for fixation. A tip of end we of winding wire 20a is connected to winding terminal 31a via solder 35. In other words, second projection 12a is disposed on wire route WL which connects winding terminal 31a with coil TC via winding wire 20a, in which condition end we of winding wire 20a is wound around second projection 12a. On the other hand, first projection 11a is disposed out of winding wire route WL, in which condition winding wire 20a is not wound around first projection 11a. Winding wire 20a is not wound around first projection 11a because first projection 11a is a portion to which winding wire 20a is only temporarily attached. After winding, winding wire 20a wound around first projection 11a is removed.

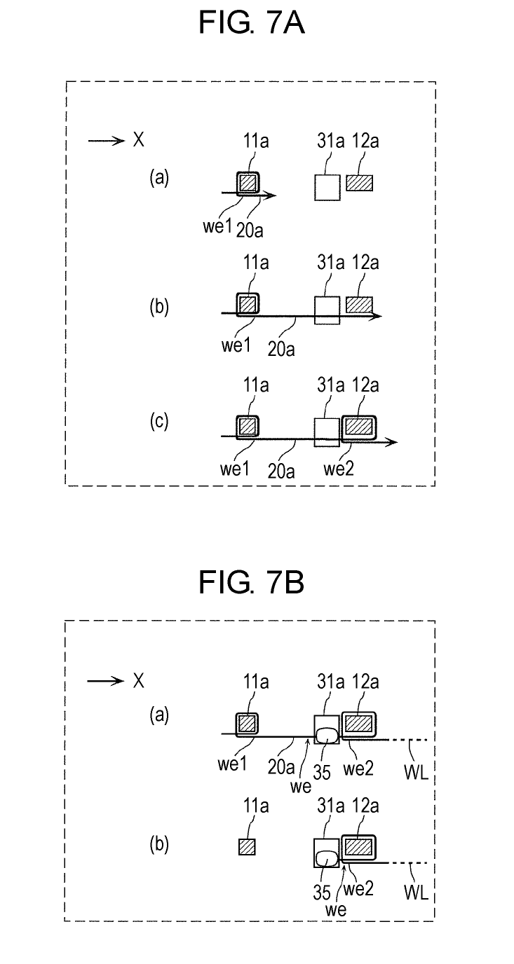

More specifically, as illustrated in (a) in FIG. 7A, winding wire 20a is wound around first projection 11a to be temporarily fixed to first projection 11a. Subsequently, winding wire 20a is routed to second projection 12a as illustrated in (b) in FIG. 7A, and then wound around second projection 12a as illustrated in (c) in FIG. 7A. After completion of a series of winding processes, winding wire 20a positioned between first projection 11a and second projection 12a is soldered to winding terminal 31a as illustrated in (a) in FIG. 7B. Thereafter, unnecessary winding wire 20a between first projection 11a and winding terminal 31a is removed as illustrated in (b) in FIG. 7B.

As described above, lens holder 1 according to the present exemplary embodiment includes first projection 11a. In this case, winding wire 20a is connectable to winding terminal 31a in a state that winding wire 20a has been fixed by using first projection 11a and second projection 12a, for example. Accordingly, conductive connection of winding wire 20a is easily achievable.

The foregoing relationship is also applicable to relationships between winding wires 20b, 20c, first projections 11b, 11c, second projections 12b, 12c, winding terminals 31b, 31c, and lead terminals 32b, 32c. In (a) in FIG. 4, second projection 12b is shown above second projection 12a, for example, for preferential depiction of winding wire 20b.

### [4. Method for Manufacturing Lens Holder]

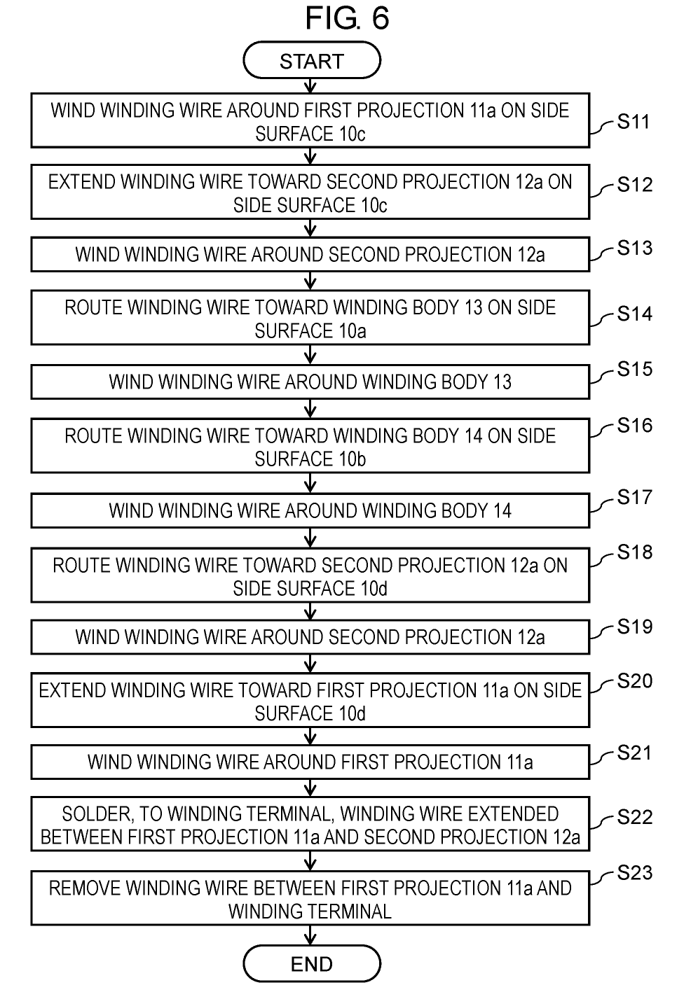

A method for manufacturing lens holder 1 is now described with reference to FIG. 6. FIG. 6 is a flowchart showing the method for manufacturing lens holder 1.

Described herein is a method for forming coil TC as a typical example of sets of three coils TC, FC1, FC2 of lens holder 1. According to the present exemplary embodiment, routing, winding, and other processing of winding wire 20a are performed by using an automatic winding machine which includes a needle movable in directions of three or more axes.

Initially, first part we1 of end we of winding wire 20a is wound around first projection 11a provided on side surface 10c, and fixed to first projection 11a (S11: see (a) in FIG. 7A). For example, a winding number of this winding is set in a range from 2 to 10 turns.

Subsequently, winding wire 20a is routed from first projection 11a to second projection 12a provided on side surface 10c (S12: see (b) in FIG. 7A). As a result, winding wire 20a is extended to a position overlapping with winding terminal 31a as viewed in a direction perpendicular to side surface 10c.

Subsequently, second part we2 of end we of winding wire 20a is wound around second projection 12a and fixed to second projection 12a (S13: see (c) in FIG. 7A) For example, a winding number of this winding is set in a range from 2 to 10 turns. Second part we2 of end we of winding wire 20a herein is a portion located closer to a center of winding wire 20a than first part we1 of end we of winding wire 20a wound around first projection 11a is.

Subsequently, winding wire 20a is routed from second projection 12a toward winding body 13 provided on side surface 10a (S14). Thereafter, winding wire 20a is wound around winding body 13 (S15). For example, a winding number of this winding is set to 30 turns.

Subsequently, winding wire 20a is routed from winding body 13 toward winding body 14 provided on side surface 10b along a projection provided on the top surface 10e side of holder body 10 (S16). Thereafter, winding wire 20a is wound around winding body 14 (S17). For example, a winding number of this winding is set to 30 turns.

Subsequently, winding wire 20a is routed from winding body 14 toward second projection 12a provided on side surface 10d (S18). Thereafter, second part we2 of end we of winding wire 20a is wound around second projection 12a, and fixed to second projection 12a (S19). For example, a winding number of this winding is set in a range from 2 to 10 turns. Second part we2 of end we of winding wire 20a herein is a portion located closer to the center of winding wire 20a than first part we1 of end we of winding wire 20a wound around first projection 11a in a subsequent step is.

Subsequently, winding wire 20a is routed from second projection 12a toward first projection 11a provided on side surface 10d (S20). As a result, winding wire 20a is extended to a position overlapping with winding terminal 31a as viewed in a direction perpendicular to side surface 10d.

Thereafter, first part we1 of end we of winding wire 20a is wound around first projection 11a, and fixed to first projection 11a (S21). For example, a winding number of this winding is set in a range from 2 to 10 turns.

Subsequently, a portion of winding wire 20a extended between first projection 11a and second projection 12a provided on side surface 10c is soldered to winding terminal 31a provided on side surface 10c. Similarly, a portion of winding wire 20a extended between first projection 11a and second projection 12a provided on side surface 10d is soldered to winding terminal 31a provided on side surface 10d (S22: see (a) in FIG. 7B). This soldering is performed in a state that winding wire 20a has been fixed to each of first projection 11a and second projection 12a, and a state that winding terminal 31a is disposed on a rear side of winding wire 20a extended between first projection 11a and second projection 12a. Accordingly, winding wire 20a is easily soldered to winding terminal 31a.

Thereafter, winding wire 20a wound around first projection 11a, and winding wire 20a provided between first projection 11a and winding terminal 31a are removed by using a tool such as tweezers (S23: see (b) in FIG. 7B). The winding process of coils TC is now completed.

Similarly, steps S11 through S23 are performed for each of winding wires 20b, 20c to form two pairs of coils FC1, FC2. More specifically, winding wire 20b is wound around first projection 11b and second projection 12b that are provided on side surface 10c, winding body 16 provided on side surface 10b, winding body 15 provided on side surface 10a, and second projection 12c and first projection 11c that are provided on side surface 10c in this order. Thereafter, soldering and removal of unnecessary winding wires are performed. As a result, a pair of coils FC1 are formed. Similarly, winding wire 20c is wound around first projection 11b and second projection 12b that are provided on side surface 10d, winding body 18 provided on side surface 10b, winding body 17 provided on side surface 10a, and second projection 12c and first projection 11c that are provided on side surface 10d in this order. Thereafter soldering and removal of unnecessary winding wires are performed. As a result, a pair of coils FC2 are formed.

Respective steps in S11 through S21 for coils TC, FC1, FC2 may be performed before execution of steps in S22 and S23. In this case, the steps in S22 and S23 are collectively performed. Manufacture of lens holder 1 including coils TC, FC1, FC2 is completed after winding of winding wires 20a through 20c by the foregoing steps.

Object lens driving device 2 is manufactured by following steps, for example. After completion of the step in S23, object lens 40 is attached to lens holder 1. Housing 50 to which second ends Le2 of leads 56a through 56c have been attached, and lens holder 1 described above are mounted on a jig. First ends Le1 of leads 56a through 56c are soldered to lead terminals 32a through 32c. Manufacture of object lens driving device 2 is now completed by the foregoing steps.

### [5. Effects and Others]

As described above, lens holder 1 according to the present exemplary embodiment includes holder body 10 and winding wire (e.g., winding wire 20a) wound around holder body 10. Holder body 10 includes: a winding body (e.g., winding body 13); a first projection (e.g., first projection 11a) and a second projection (e.g., second projection 12a) each projecting from a surface of holder body 10; and a winding terminal (e.g., winding terminal 31a) positioned between first projection 11a and second projection 12a, and provided on the surface of holder body 10. A part of winding wire 20a is wound around winding body 13 to form a coil (e.g., coil TC). End we of winding wire 20a is wound around second projection 12a and connected to winding terminal 31a.

According to lens holder 1 including first projection 11a, winding wire 20a is thus connectable to winding terminal 31a positioned between first projection 11a and second projection 12a in a state that winding wire 20a has been fixed by using first projection 11a and second projection 12a, for example. Accordingly, conductive connection of winding wire 20a is easily achievable. Moreover, connection of winding wire 20a to winding terminal 31a while fixing winding wire 20a to winding terminal 31a improves connection stability between winding wire 20a and winding terminal 31a.

Second projection 12a may be disposed on wire route WL that connects winding terminal 31a with coil TC via winding wire 20a, while first projection 11a may be disposed out of wire route WL.

When first projection 11a is disposed out of wire route WL as described above, unnecessary winding wire 20a positioned between first projection 11a and winding terminal 31a is easily removable after connection between winding wire 20a and winding terminal 31a, for example. Accordingly, a removing process of unnecessary wiring after connection of winding wire 20a to winding terminal 31a is easily achievable.

Winding terminal 31a may be a land-shaped electrode, while end we of winding wire 20a may be connected to winding terminal 31a via solder 35.

According to this configuration, end we of winding wire 20a is easily connectable to winding terminal 31a.

Holder body 10 may include wiring substrate 30 provided between first projection 11a and second projection 12a, while winding terminal 31a may be formed on a surface of wiring substrate 30.

According to this configuration, winding terminal 31a is easily formed on holder body 10.

Holder body 10 may include the pair of side surfaces 10c, 10d. First projections 11a and second projections 12a may project from each of the pair of side surfaces 10c, 10d.

According to this configuration, conductive connection of winding wire 20a is easily made on each of two side surfaces 10c, 10d of holder body 10.

A plurality of wire routes WL may be provided to connect winding terminals 31a, 31b, 31c with corresponding coils TC, FC1, FC2 via corresponding winding wires 20a, 20b, 20c. A plurality of sets (three sets in present exemplary embodiment) each including one first projection, one winding terminal, and one second projection, i.e., first projections 11a, 11b, 11c, winding terminals 31a, 31b, 31c, and second projections 12a, 12b, 12c, are provided on each of the side surfaces (e.g., side surface 10c) of holder body 10, in correspondence with the plurality of wire routes WL.

When lens holder 1 includes the plurality of sets of first projections 11a through 11c and second projections 12a through 12c, in correspondence with the plurality of winding wires 20a through 20c as described above, conductive connection of winding wires 20a through 20c to the plurality of winding terminals 31a through 31c is easily achievable.

A projection amount of first projection 11a from side surface 10c may be larger than a projection amount of second projection 12a from side surface 10c.

This configuration allows first projection 11a to abut on housing 70 surrounding side surfaces of object lens driving device 2, reducing shock even when sudden acceleration is applied to, in the Y direction, optical pickup device 3 mounted with lens holder 1, for example.

The projection amount of first projection 11a from side surface 10c may be smaller than the projection amount of second projection 12a from side surface 10c.

This configuration secures a space for insertion of a tool for soldering in connection of winding wire 20a to winding terminal 31a, for example.

The projection amount of first projection 11a from side surface 10c may be equal to the projection amount of second projection 12a from side surface 10c.

Object lens driving device 2 according to the present exemplary embodiment includes: lens holder 1 described above; object lens 40 fixed to holder body 10; a lead (e.g., lead 56a) having first end Le1 connected to holder body 10; housing 50 connected to second end Le2 of lead 56a and configured to support holder body 10 via lead 56a; and magnets 60a, 60b fixed to housing 50.

When lens holder 1 capable of easily achieving conductive connection as described above is used, productivity of object lens driving device 2 increases. Moreover, when lens holder 1 capable of improving connection stability between winding wire 20a and winding terminal 31a is used, electric connection stability of object lens driving device 2 improves.

A lead terminal (e.g., lead terminal 32a) conductively connected to the winding terminal (e.g., winding terminal 31a) may be further provided on the surface of holder body 10, while first end Le1 of lead 56a may be connected to lead terminal 32a.

According to this configuration, conductive connection between lead 56a and winding wire 20a is easily achievable via lead terminal 32a and winding terminal 31a.

Optical pickup device 3 according to the present exemplary embodiment includes: object lens driving device 2 described above; and housing 70 that fixes housing 50 of object lens driving device 2.

When object lens driving device 2 with improved productivity as described above is used, productivity of optical pickup device 3 improves.

A method for manufacturing lens holder 1 according to the present exemplary embodiment includes following steps. According to the manufacturing method described in the present exemplary embodiment, winding wire 20a is wound around first projection 11a or second projection 12a for fixation. However, for the purpose of fixation, winding wire 20a may be embedded in a recess or pinched by a clip, rather than wound. In the following method for manufacturing lens holder 1, it is assumed that first projection 11a constitutes a first fixing portion, and that second projection 12a constitutes a second fixing portion.

According to the method for manufacturing lens holder 1 in the present exemplary embodiment, lens holder 1 includes the first fixing portion (corresponding to first projection 11a) that fixes first part we1 included in end we of winding wire 20a, the second fixing portion (corresponding to second projection 12a) that fixes second part we2 included in end we of winding wire 20a and located closer to a center of winding wire 20a than first part we1 of end we of winding wire 20a is, a winding body (e.g., winding body 13) located closer to the center of winding wire 20a than the second fixing portion is, and winding terminal 31a located between the first fixing portion and the second fixing portion. The method for manufacturing lens holder 1 includes: fixing first part we1 of winding wire 20a to the first fixing portion; extending winding wire 20a to connect the first fixing portion with the second fixing portion; fixing second part we2 of winding wire 20a to the second fixing portion; routing winding wire 20a to connect the second fixing portion with winding body 13; winding winding wire 20a around winding body 13; and soldering, to winding terminal 31a, a portion of winding wire 20a extended between the first fixing portion and the second fixing portion.

According to this method, winding wire 20a is connectable to winding terminal 31a positioned between the first fixing portion and the second fixing portion in a state that winding wire 20a has been fixed by using the first fixing portion and the second fixing portion. Accordingly, conductive connection of winding wire 20a is easily achievable. Moreover, connection of winding wire 20a to winding terminal 31a while fixing winding wire 20a to winding terminal 31a improves connection stability between winding wire 20a and winding terminal 31a.

### Other Exemplary Embodiments

The exemplary embodiment has been described above as a specific example of the technology disclosed in the present application. However, the technology of the present disclosure is not limited to the exemplary embodiment described herein, but is applicable to other exemplary embodiments in which a change, a replacement, an addition, or an omission is appropriately made. Respective constituent elements described in the above exemplary embodiment may be combined to present a new exemplary embodiment. Described below are exemplary embodiments presented as different examples.

For example, the projection amount of first projection 11a of lens holder 1 from side surface 10c may be equal to or larger than the projection amount of second projection 12a from side surface 10c. This structure allows first projection 11a to abut on inner wall 71 (see FIG. 1) of housing 70 surrounding side surfaces of object lens driving device 2, reducing shock even when sudden acceleration is applied to optical pickup device 3 in the Y direction. Moreover, this structure prevents a contact between inner wall 71 of housing 70 and second projection 12a around which winding wire 20a has been wound, thereby reducing loosening or deformation of winding wire 20a.

For example, a thickness of a tip of first projection 11a may be smaller than a thickness of a middle portion of first projection 11a. According to this structure, winding wire 20a is easily separated and removed from first projection 11a after the winding process.

On the other hand, a thickness of a tip of second projection 12a may be larger than a thickness of a middle portion of second projection 12a. According to this structure, separation of winding wire 20a from second projection 12a is avoidable during or after winding of winding wire 20a around second projection 12a.

According to the method for manufacturing lens holder 1, lens holder 1 may be configured to be handled by a robot hand or the like, and turned by 90 degrees in an X-Y plane. According to this configuration, routing efficiency of winding wire 20a increases.

The turn numbers or the winding numbers of the winding wires around the first projection, the second projection, and the winding bodies are not limited to the turn numbers or the winding numbers specified in the present disclosure.

The exemplary embodiment has been described as an example of the technology according to the present disclosure. The accompanying drawings and detailed description have been presented for this purpose.

Accordingly, the constituent elements depicted and described in the accompanying drawings and the detailed description may include not only constituent elements essential for solutions to problems, but also constituent elements not essential for solutions to problems and included to present only specific examples of the technology. It should not therefore be determined that the unessential constituent elements included in the accompanying drawings and the detailed description are essential only based on the fact that these constituent elements are included in the drawings and the description.

Moreover, the exemplary embodiment, as presented only by way of example of the technology according to the present disclosure, may include various modifications, replacements, additions, and omissions and the like, without departing from a range defined by the appended claims and a range equivalent to this range.

The present disclosure is applicable to a recording and reproducing device which writes and reads information to and from a recording medium such as a CD, a DVD, and a Blu-ray (registered trademark) disc.

What is claimed is:

1. A method for manufacturing a lens holder around which a winding wire is wound, the lens holder including:
a first fixing portion that fixes a first part included in an end of the winding wire;
a second fixing portion that fixes a second part included in the end of the winding wire and located closer to a center of the winding wire than the first part of the end of the winding wire is;
a winding body located closer to the center of the winding wire than the second fixing portion is; and
a winding terminal located between the first fixing portion and the second fixing portion,
the method comprising:
fixing the first part of the winding wire to the first fixing portion;
extending the winding wire to connect the first fixing portion with the second fixing portion;
fixing the second part of the winding wire to the second fixing portion;
routing the winding wire to connect the second fixing portion with the winding body;
winding the winding wire around the winding body; and
soldering, to the winding terminal, the winding wire extended between the first fixing portion and the second fixing portion.
